(19) United States
(12) Patent Application Publication
(10) Pub. No.: US 2015/0332524 A1
(43) Pub. Date: Nov. 19, 2015

(54) SYSTEM AND METHOD FOR MONITORING MACHINE

(71) Applicant: Caterpillar Inc., Peoria, IL (US)

(72) Inventor: Eric J. Johannsen, Washington, IL (US)

(73) Assignee: Caterpillar Inc., Peoria, IL (US)

(21) Appl. No.: 14/807,931

(22) Filed: Jul. 24, 2015

(51) Int. Cl. G07C 5/02; G07C 5/08

(52) U.S. Cl. CPC G07C 5/02; G07C 5/08

(57) ABSTRACT

A method for monitoring an operation of a tracked machine is provided. The method includes receiving signals indicative of a plurality of operating parameters associated with the tracked machine. The plurality of operating parameters includes at least of one of an impact force on an undercarriage system of the tracked machine, a machine speed, and a drive torque. The method also includes applying a baseline limit for each of the at least one signal. The method further includes comparing the at least one signal with a corresponding baseline limit. The method includes providing a communication when the at least one signal exceeds the respective baseline limit.

### TECHNICAL FIELD

The present disclosure relates to a system and method for monitoring a machine, and more particularly to the system and method for monitoring one or more operations of a tracked machine.

### BACKGROUND

In a manually operated machine, an operator seated inside an operator cabin of the machine performs various machine operations. Some operating practices followed by the operator may have an impact on the wear and tear of machine components, such as undercarriage components of the machine or machine implements. If such operating conditions are periodically repeated, the possibility of damage of the machine components may increase, thereby increasing maintenance costs and downtime associated with the machine. Currently, there are no methods to notify or advise the operator of the machines if their operating practices are damaging or causing excess wear to the machine components.

U.S. Published Application Number 2014/0277832 describes an abnormal driving behavior detection system for a vehicle. An obtainer repeatedly obtains an observed value indicative of at least one of a running condition of the vehicle and a driver's driving operation of the vehicle. The system includes a mode-probability calculator calculates, each time an observed value is obtained at a given obtaining timing as a target obtained value, a mode probability for each of driving modes as a function of one or more previous observed values. The system also includes a deviation calculator obtains a predicted observed value for each driving mode using a driver's normal behavior model defined therefor, and calculates a deviation of the target observed value from the predicted observed value for each driving mode. The system further includes an abnormality determiner determines whether there is at least one driver's abnormal behavior based on the mode probability for each driving mode and the deviation calculated for each driving mode.

### SUMMARY OF THE DISCLOSURE

In one aspect of the present disclosure, a method for monitoring an operation of a tracked machine is provided. The method includes receiving signals indicative of a plurality of operating parameters associated with the tracked machine. The plurality of operating parameters includes at least one of an impact force on an undercarriage system of the tracked machine, a machine speed, and a drive torque. The method also includes applying a baseline limit for each of the at least one signal. The method further includes comparing the at least one signal with a corresponding baseline limit. The method includes providing a communication when the at least one signal exceeds the respective baseline limit.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a block diagram of an exemplary system for monitoring an operation of the machine of FIG. 1, according to one embodiment of the present disclosure; and

FIG. 3 is a flowchart for a method of monitoring the operation of the machine.

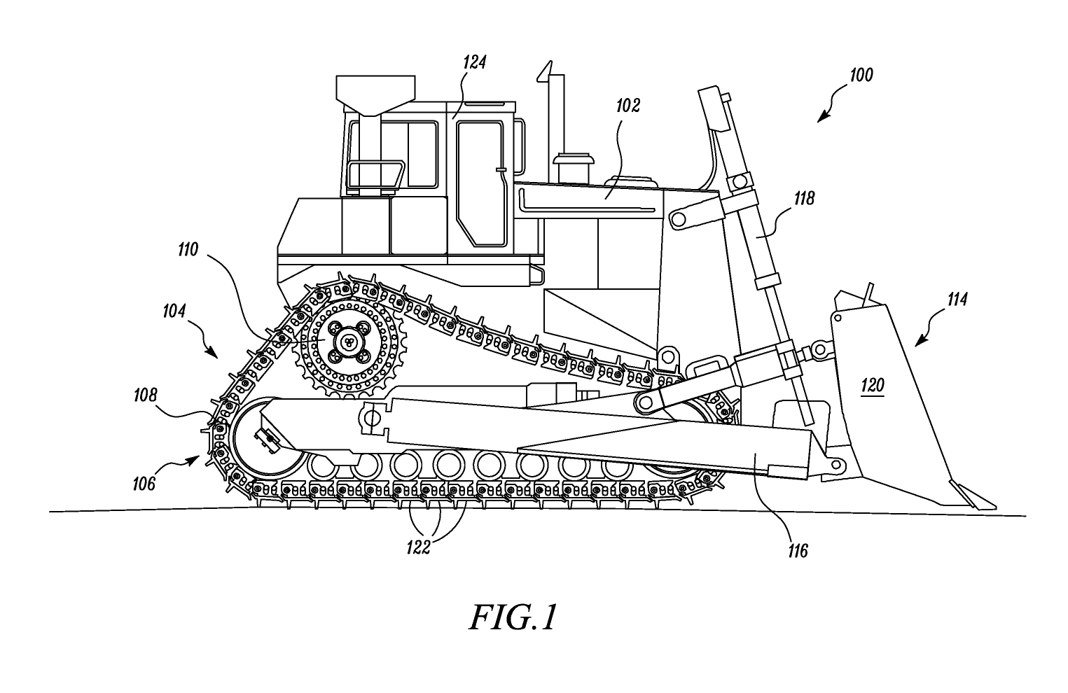

### DETAILED DESCRIPTION

Wherever possible, the same reference numbers will be used throughout the drawings to refer to the same or the like parts. FIG. 1 illustrates an exemplary machine 100, according to one aspect of the present disclosure. As illustrated, the machine 100 is embodied as a track type tractor. Alternatively, the machine 100 may include a backhoe loader, a skid steer loader, a wheel loader, a motor grader, and the like. It should be understood that the machine 100 may embody any wheeled or tracked machine associated with mining, agriculture, forestry, construction, and other industrial applications.

As illustrated in FIG. 1, the machine 100 may include a power source (not shown) provided in an enclosure 102, a transmission system (not shown), and a propulsion system 104. In one embodiment, the power source may include, for example, a diesel engine, a gasoline engine, a gaseous fuel powered engine such as a natural gas engine, a combination of known sources of power or any other type of engine apparent to one of skill in the art. In the present embodiment, the power source is disposed near a front portion of the machine 100. Further, the transmission system of the machine 100 may be communicably coupled to the power source. The transmission system may include coupling elements for transmitting a drive torque from the power source to the propulsion system 104.

The propulsion system 104 includes an undercarriage system 106 to propel the machine 100 on the ground. The undercarriage system 106 includes two separate continuous tracks 108, one on either side of the machine 100 (only one of which is shown in FIG. 1). Each of the tracks 108 may be driven by the power source via one or more sprockets 110. The tracks 108 include multiple track shoes 122, each of which are configured to selectively engage a surface, e.g., the ground.

The machine 100 also includes a load lifting assembly 114 having a lift arm 116, one or more hydraulic actuators 118 and an implement 120. The hydraulic actuators 118 are configured to effectuate movement of the load lifting assembly 114 based on an operator command provided by an operator of the machine 100. The implement 120 may include any one of a blade, a bucket or a ripper, and the like. In the illustrated embodiment, the implement 120 is a blade. The blade is configured to move material and/or heavy objects on the ground.

The machine 100 includes an operator cabin 124. The operator command may be received through various input devices present within the operator cabin 124 of the machine 100. In some examples, when the operator is performing a machine operation, one or more poor operating practices by the operator may cause excess wear, and in some situations, damage the components of the machine 100, such as the undercarriage system 106 or the implement 120.

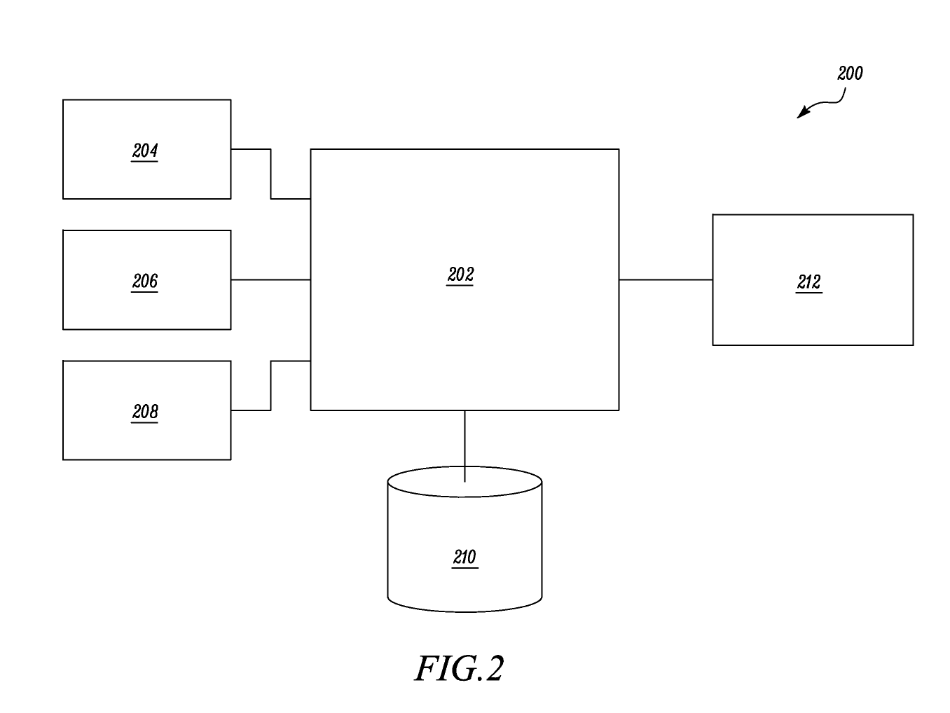

A system 200 for monitoring one or more operations of the machine 100 will now be explained in detail with reference to FIG. 2. The system 200 includes a parameter detection module 202. The parameter detection module 202 is configured to receive signals indicative of one or more operating parameters associated with the machine 100. In one example, the one or more operating parameters include at least one of an impact force exerted on the undercarriage system 106 of the machine 100, a speed of the machine 100, and the drive torque. However, the parameter detection module 202 may also receive signals pertaining to operating parameters that are not listed herein, without limiting the scope of the present disclosure.

The parameter detection module 202 is communicably coupled to a number of sensors located on-board the machine 100 and are configured to receive signals therefrom. In one example, the parameter detection module 202 is communicably coupled with a first sensor 204. The parameter detection module 202 is configured to receive signals from the first sensor 204. The first sensor 204 is configured to detect and generate a signal indicative of the impact forces exerted on the components of the undercarriage system 106 of the machine 100 due to g-forces. The term “g-forces” described herein is indicative of accelerations that may exert the impact forces on the components of the undercarriage system 106. In another example, the first sensor 204 may be configured to detect and generate a signal indicative of the impact forces on the implement 120 of the machine 100. The first sensor 204 may embody an accelerometer. Alternatively, the first sensor 204 may embody any impact detection devices known in the art that is configured to determine the impact forces due to the g-forces.

The system 200 also includes a second sensor 206. The parameter detection module 202 is communicably coupled to the second sensor 206 and is configured to receive signals therefrom. The second sensor 206 is configured to generate a signal corresponding to the speed of the machine 100. In one example, the second sensor 206 is configured to determine both forward speeds and reverse speeds of the machine 100. The second sensor 206 may include any one of a known contact type or contactless type speed measurement means known in the art. The second sensor 206 may include a wheel speed sensor, LIDAR, a speedometer, and the like, without any limitations.

Further, the parameter detection module 202 is communicably coupled to a third sensor 208. The third sensor 208 is configured to determine and generate signals corresponding to the drive torque, and more particularly, the final drive torque of the machine 100. In one example, the third sensor 208 may embody a torque sensor. The torque sensor may be associated with the engine or the transmission system of the machine 100 in order to measure the final drive torque. Alternatively, the third sensor 208 may include any known torque measuring means known in the art.

The parameter detection module 202 is configured to receive signals from the first, second, and third sensors 204, 206, 208 on a real time basis. Further, the parameter detection module 202 is configured to apply baseline limits corresponding to each of the operating parameters received from the respective sensors 204, 206, 208. The baseline limits correspond to preferred values of operating parameters for the machine 100. Each baseline limit may include an upper baseline limit and a lower baseline limit, such that the preferred values of operating parameters fall within the upper and lower baseline limits. The baseline limits may be retrieved from a database 210 that is communicably coupled with the parameter detection module 202. The database 210 may store the baseline limits corresponding to the various operating parameters. As per system requirements, the baseline limits stored in the database 210 may be updated and modified on a real time basis.

Further, the parameter detection module 202 is configured to compare the signals corresponding to the one or more operating parameters received from the respective sensors 204, 206, 208 with the respective baseline limits. In a situation wherein the one or more operating parameters do not fall within the upper and lower baseline limits, the parameter detection module 202 is configured to trigger a notification to the operator of the machine 100 via an output module 212. In one example, the notification may alert the operator of any variations in the operating parameters of the machine 100 that may cause damage to the machine 100. In another example, the notification may advise or provide feedback to the operator to control the operating parameters of the machine 100.

In one situation, when the speed of the machine 100 exceeds the set upper baseline limit, the parameter detection module 202 may alert the operator that the speed of the machine 100 does not fall within the respective upper and lower baseline limits. For example, if the machine 100 is operating at a speed higher than 9 kmph for more than 60 minutes in the forward direction, the parameter detection module 202 may trigger a notification to the operator to control the forward speed of the machine 100. In another situation, if the machine 100 is operating at a speed higher than 9 kmph for more than 20 minutes in the reverse direction, the parameter detection module 202 may trigger a notification to the operator to control the reverse speed of the machine 100.

In another example, wherein the signals corresponding to the drive torque of the machine 100 does not fall within the respective upper and lower baseline limits, the parameter detection module 202 may trigger the notification to the operator of the machine 100 to take corrective measures to limit the drive torque. For example, if the drive torque of the machine 100 exceeds 95% of the maximum torque for a certain period of time or if the machine 100 exceeds 95% of the maximum torque for a certain number of times per hour, the parameter detection module 202 may trigger a notification to the operator to control the drive torque of the machine 100.

The communication between the parameter detection module 202 and the output module 212 may be wired or wireless, based on the type of application. Further, the output module 212 may be located on-board the machine 100. The output module 212 may be mounted at a location such that the output module 212 may be viewable to the operator. For example, the output module 212 may be present in the operator cabin 124 of the machine 100, and may be viewable on the operator interface. Alternatively, the output module 212 may form a part of a dashboard of the machine 100, and may be provided adjacent to a speedometer or a fuel level indicator. In one embodiment, the output module 212 may be present at a remote location, for example, at a base station.

The output module 212 may embody a visual output or an audio output. In a situation wherein the output module 212 is embodied as the audio output, the notification may be heard in the form of an audio clip. In one example, in case of the audio output, an alarm generated by the output module 212 may notify the operator that the one or more operating parameter does not correspond to the baseline limits. In another example, wherein the output module 212 is embodied as a visual output, the output module 212 may include any one of a digital display device, a Liquid Crystal Display (LCD) device, a Light-Emitting Diode (LED) device, a cathode ray tube (CRT) monitor, a touchscreen device, or any other display device known in the art. In one example, the output module 212 may notify the operator of any discrepancies in the operating parameters of the machine 100 and the respective baseline limits through a text message.

Alternatively, the output module 212 may include an indicator light. An LED light or an LCD light may be used to notify the person whether or not the operating parameters match with the baseline limits. It should be noted that the output module 212 may include any other means other than those listed above.

In another exemplary embodiment, results generated by the parameter detection module 202 after the comparison between the one or more operating parameters and the respective baseline limits may be directly transmitted to the database 210. As per requirements, the results may be later retrieved from the database 210 by an algorithm or an expert. The results stored in the database 210 may be analyzed and processed to monitor operator performance or to determine wear of the machine components.

The parameter detection module 202 may embody a single microprocessor or multiple microprocessors for receiving signals from components of the system 200. Numerous commercially available microprocessors may be configured to perform the functions of the parameter detection module 202. A person of ordinary skill in the art will appreciate that the parameter detection module 202 may additionally include other components and may also perform other functions not described herein.

### INDUSTRIAL APPLICABILITY

The present disclosure relates to the system 200 to monitor operations of the machine 100. The system 200 also triggers the alarm to notify the operator of any variations in the operating parameters of the machine 100 that may cause damage to the machine 100. The system 200 processes signals from the sensors 204, 206, 208 that are present on-board the machine 100 to advise the operator/owner of the machine 100 when they use operating practices that cause excess wear or damage to the machine components. As the system 200 makes use of existing sensors 204, 206, 208 present on the machines 100, the system 200 presents a cost effective solution.

Additionally, the determination may assist in analyzing the effect on wear rates due to the operating practices of the operator so that the results of the wear rate may assist in scheduling of maintenance activities on the machines 100. Further, the system 200 may also provide inputs for analyzing operator performance based on the operating practices. The system 200 disclosed herein is reliable in operation.

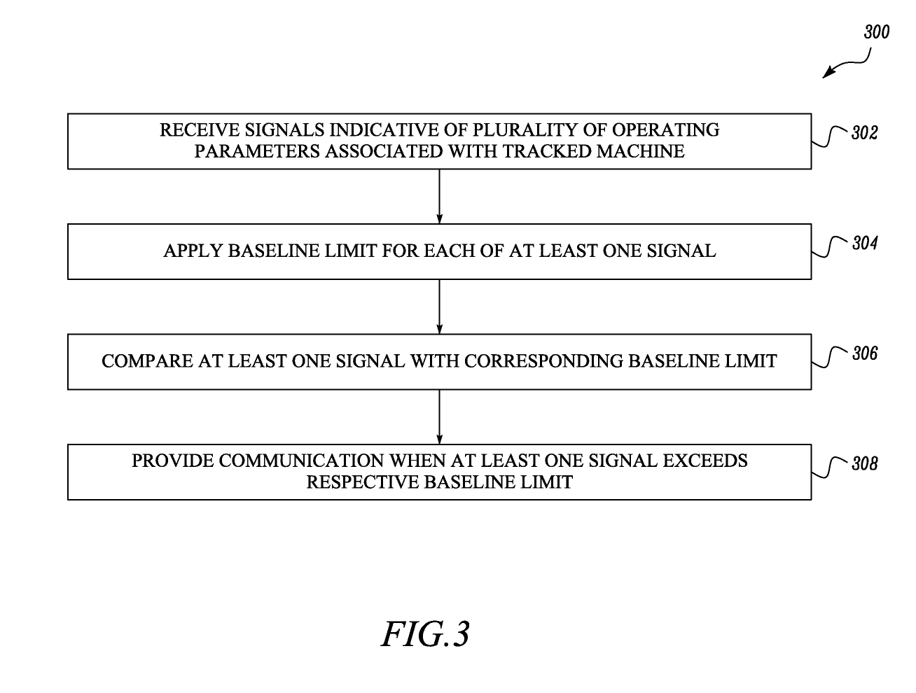

FIG. 3 is a flowchart for a method 300 for monitoring the operation of the tracked machine 100. At step 302, the signals indicative of the operating parameters associated with the machine 100 is received from the parameter detection module 202. The operating parameters may include the impact force on the undercarriage system 106 of the machine 100, the machine speed, the drive torque, and so on.

At step 304, the parameter detection module 202 applies the baseline limit for each of the signals received from the sensors 204, 206, 208. At step 306, the parameter detection module 202 compares the signal with the corresponding baseline limit. At step 308, the parameter detection module 202 communicates to the operator when the signal exceeds the respective baseline limit. Although, the current disclosure describes the use of three sensors 204, 206, 208, the system 200 may include additional sensors for determining operating parameters other than those disclosed herein, without any limitations. Further, the type of sensors used may also vary based on the operating parameter to be determined.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for monitoring an operation of a tracked machine, the method comprising:
receiving signals indicative of a plurality of operating parameters associated with the tracked machine, the plurality of operating parameters including at least of an impact force on an undercarriage system of the tracked machine, a machine speed, and a drive torque;
applying a baseline limit for each of the at least one signal;
comparing the at least one signal with a corresponding baseline limit; and
providing a communication when the at least one signal exceeds the respective baseline limit.
